(19) United States
(12) Patent Application Publication
(10) Pub. No.: US 2014/0172342 A1
(43) Pub. Date: Jun. 19, 2014

(54) TIRE PRESSURE SENSOR DEVICE SETTING METHOD

(71) Applicant: CUB ELECPARTS INC., Fuxing Township (TW)

(72) Inventors: San-Chuan YU, Fuxing Township (TW); Tzu-Wen KO, Changhua City (TW); Chi-Hung CHEN, Fuxing Township (TW)

(73) Assignee: CUB ELECPARTS INC., Fuxing Township (TW)

(21) Appl. No.: 13/715,619

(22) Filed: Dec. 14, 2012

(51) Int. Cl. G01L 27/00

(52) U.S. Cl. CPC G01L 27/005
USPC 702/104

(57) ABSTRACT

A tire pressure sensor device setting method includes the step of: installing the tire pressure sensor device in a tire and starting it up, the step of enabling the main control processor to match the detected tire pressure value with a predetermined tire pressure reference value, the step of enabling the main control processor to accept a wireless signal from the receiver for altering the communication protocol of the tire pressure sensor device if the detected tire pressure value is greater than the tire pressure reference value, and the step of stopping the main control processor from receiving a wireless signal from the receiver so that the communication protocol of the tire pressure sensor device is locked up to finish the installation.

### BACKGROUND OF THE INVENTION

1. Field of the Invention

The present invention relates to tire pressure monitoring technology and more particularly, to a tire pressure sensor device setting method.

2. Description of the Related Art

Except one to one type tire pressure sensor devices, there are other two types of tire pressure sensor devices commercially available. The setting of the first one of these other two types of tire pressure sensor devices is done by: storing different communication protocol software programs in the memory of the tire pressure sensor device, and then using a setting tool to transmit a communication protocol soft program designation code and trigger code to the tire pressure sensor device after installation of the tire pressure sensor device in a vehicle tire. The setting of the second end of the foresaid other two types of tire pressure sensor devices is done by: using a setting tool to transmit the communication protocol soft program to be executed to the tire pressure sensor device, which does not have any communication protocol software program set therein, after installation of the tire pressure sensor device in a vehicle tire, so that the tire pressure sensor device can store the received communication protocol software program in the memory thereof and run it. When using a setting tool to set either of the aforesaid two other two types of tire pressure sensor devices, signal transmission is performed wirelessly at the frequency of 315 KHz or 433 KHz. However, because wireless transmission is a non-directional transmission, error setting or alteration of setting by mistake may occur during the setting operation. For example, when the operator sets the tire pressure sensor device at the left front wheel, the tire pressure sensor device at the right front wheel may receive the setting signal that is to be transmitted to the tire pressure sensor device at the left front wheel, resulting in a setting mistake, or when the operator is setting one tire pressure sensor device of a car A, the tire pressure sensor devices of a nearby car B may receive the setting signal to have the existing setting be altered by mistake.

### SUMMARY OF THE INVENTION

The present invention has been accomplished under the circumstances in view. It is the main object of the present invention to provide a tire pressure sensor device setting method, which automatically locks up the setting after the setting is done.

It is another object of the present invention to provide a tire pressure sensor device setting method, which allows the setting of the tire pressure sensor device to be started subject to a specific operation step.

It is still another object of the present invention to provide a tire pressure sensor device setting method, which prevents the setting of the tire pressure sensor device from being altered by mistake or erroneously set.

To achieve these and other objects of the present invention, a tire pressure sensor device setting method comprises the step of: installing the tire pressure sensor device in a tire and starting it up, the step of enabling the main control processor to match the detected tire pressure value with a predetermined tire pressure reference value, the step of enabling the main control processor to accept a wireless signal from the receiver for altering the communication protocol of the tire pressure sensor device if the detected tire pressure value is greater than the tire pressure reference value, and the step of stopping the main control processor from receiving a wireless signal from the receiver so that the communication protocol of the tire pressure sensor device is locked up to finish the installation.

Further, in accordance with the tire pressure sensor device setting method, the tire pressure sensor device has mounted therein a blank memory unit.

Further, in an alternate form of the tire pressure sensor device setting method, the tire pressure sensor device has mounted therein a memory unit that has stored therein multiple communication protocol software programs.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram of a tire pressure sensor device according to the present invention.

FIG. 2 is an operation flow chart of a tire pressure sensor device setting method in accordance with a first embodiment of the present invention.

FIG. 3 is an operation flow chart of a tire pressure sensor device setting method in accordance with a first embodiment of the present invention.

### DETAILED DESCRIPTION OF THE INVENTION

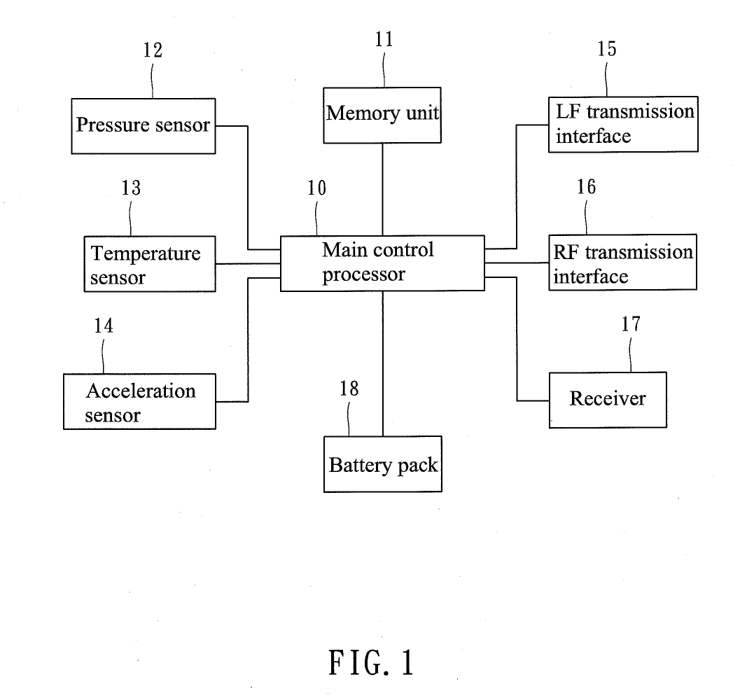

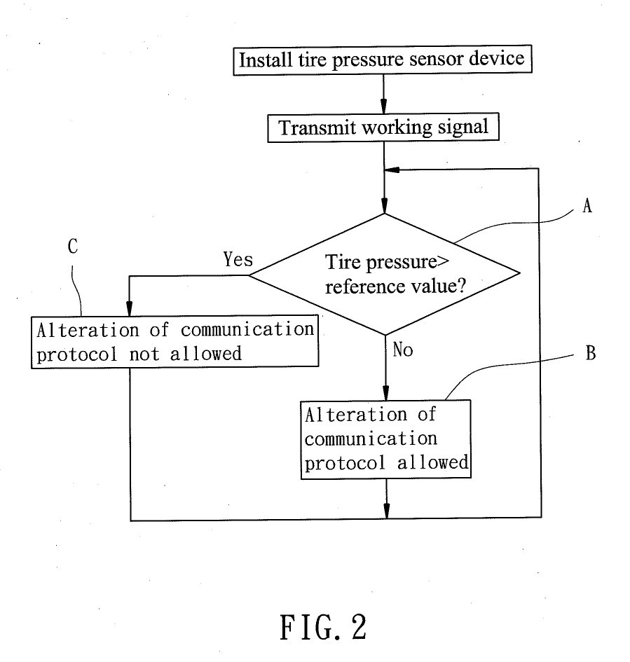

Referring to FIGS. 1 and 2, a tire pressure sensor device setting method in accordance with a first embodiment of the present invention is adapted for setting a tire pressure sensor device comprising a housing, an air nozzle located at one end of the housing, and a circuit board mounted in the housing, wherein the circuit board, as shown in FIG. 1, comprises a main control processor 10 installed in the circuit board, a memory unit 11 installed in the circuit board and electrically coupled to the main control processor 10 and having built therein multiple communication protocol software programs, a pressure sensor 12 installed in the circuit board and electrically coupled to the main control processor 10 and adapted for sensing the internal tire pressure of a tire of a vehicle, a temperature sensor 13 installed in the circuit board and electrically coupled to the main control processor 10 and adapted for sensing the internal temperature of the tire of the vehicle, an acceleration sensor 14 installed in the circuit board and electrically coupled to the main control processor 10 and adapted for sensing the acceleration value of the tire, a LF (low frequency) transmission interface 15 and a RF (radio frequency) transmission interface 16 installed in the circuit board and respectively electrically coupled to the main control processor 10 and adapted for transmitting sensed data to an on-vehicle receiver by a low frequency or radio frequency, a receiver 17 installed in the circuit board and electrically coupled to the main control processor 10 and adapted for receiving an external wireless signal and transmitting received external wireless signal to the main control processor 10, and a battery pack 18 installed in the circuit board and electrically connected with the circuit layout of the circuit board and for providing the programmable tire pressure sensor device with the necessary working power supply.

Referring to FIG. 2, the tire pressure sensor device setting method in accordance with the first embodiment of the present invention includes the following steps:
1. Install the tire pressure sensor device in a tire of a vehicle.
2. Use a setting tool to transmit a working signal containing a communication protocol designation code and trigger code to the tire pressure sensor device wirelessly to start up the tire pressure sensor device, driving the pressure sensor of the tire pressure sensor device to detect the internal tire pressure of the tire of the vehicle and to transmit sensed data to the main control processor.
3. Provide step A to enable the main control processor to monitor the parameter value and matches monitored parameter value with a predetermined reference value, determining whether nor not the detected tire pressure value is greater than the reference value? And then proceed to step B if the detected tire pressure value is smaller than the reference value, or step C if the detected tire pressure value is greater than the reference value.

When entered step B, the main control processor keeps receiving another wireless signal from the receiver, allowing alteration of the communication protocol of the tire pressure sensor device. For example, if the detected tire pressure value is 15 psi and the reference value is 28 psi, the main control processor keeps receiving another wireless signal from the receiver for altering the setting of the tire pressure sensor device.

If the detected tire pressure value is greater than the reference value, it immediately proceeds to step C. When entered step C, the main control processor stops receiving any further wireless signal from the receiver for alteration of the communication protocol of the tire pressure sensor device, and thus the installation of the tire pressure sensor device is done. For example, if the tire is inflated to the standard value of 30-35 psi, the tire pressure value at this time is greater than the reference value, and the main control processor does not receive any wireless signal from the receiver, and therefore the setting of the tire pressure sensor device is locked up.

This method prevents the setting of the installed tire pressure sensor device from being altered by mistake or erroneously set.

When going to alter the setting of the tire pressure sensor device, the operator simply needs to discharge the tire pressure to a level below the reference value. When the tire pressure becomes smaller than the reference value, the main control processor will receive a new working signal from the receiver for altering the setting of the tire pressure sensor.

The invention also provides an alternate form of the tire pressure sensor device setting method in accordance with the first embodiment of the present invention. This alternate form is substantially similar to that shown in FIG. 2 with the exception that the memory unit does not have any communication protocol software program stored therein.

This alternate form of tire pressure sensor device setting method in accordance with the first embodiment of the present invention includes the following steps:
1. Install the tire pressure sensor device in a tire of a vehicle.
2. Use a setting tool to transmit a working signal containing a communication protocol software program to the tire pressure sensor device wirelessly to start up the tire pressure sensor device, driving the pressure sensor of the tire pressure sensor device to detect the internal tire pressure of the tire of the vehicle and to transmit sensed data to the main control processor.
3. Provide step A to enable the main control processor to monitor the parameter value and matches monitored parameter value with a predetermined tire pressure reference value, determining whether nor not the detected tire pressure value is greater than the tire pressure reference value? And then proceed to step B if the detected tire pressure value is smaller than the tire pressure reference value, or step C if the detected tire pressure value is greater than the tire pressure reference value. When entered step B, the main control processor keeps receiving another wireless signal from the receiver, allowing alteration of the communication protocol of the tire pressure sensor device. For example, if the detected tire pressure value is 15 psi and the tire pressure reference value is 28 psi, the main control processor keeps receiving another wireless signal from the receiver for altering the setting of the tire pressure sensor device. When entered step C, the main control processor stops receiving any further wireless signal from the receiver for alteration of the communication protocol of the tire pressure sensor device, and thus the installation of the tire pressure sensor device is done. For example, if the tire is inflated to the standard value of 30-35 psi, the tire pressure value at this time is greater than the tire pressure reference value, and the main control processor does not receive any wireless signal from the receiver, and therefore the setting of the tire pressure sensor device is locked up.

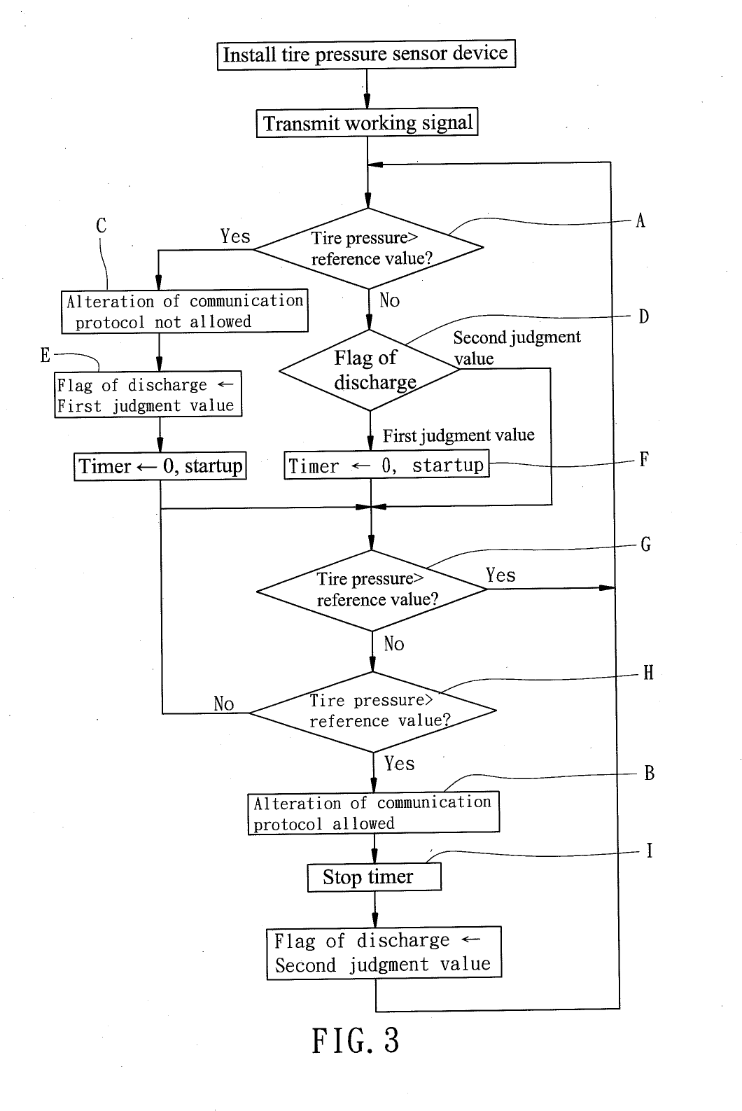

Further, in order to enhance the security when setting the tire pressure sensor device, another parameter value and a determination factor of a predetermined time value are added when the main control processor determines the tire pressure value to be greater or lower than the tire pressure reference value. As illustrated in FIG. 3, a tire pressure sensor device setting method in accordance with a second embodiment of the present invention is to perform the following steps in a proper order.

Install the tire pressure sensor device in a tire of a vehicle and start up the tire pressure sensor device.

Run step A to enable the main control processor to monitor the parameter value and matches monitored parameter value with a predetermined reference value. At this time, the main control processor matches the detected tire pressure value with the predetermined tire pressure reference value and determines whether nor not the detected tire pressure value is greater than the tire pressure reference value? And then proceed to step D if the detected tire pressure value is smaller than the reference value, or step C if the detected tire pressure value is greater than the reference value.

Run step C where the main control processor stops receiving any wireless signal from the receiver to prohibit alteration of the existing communication protocol of the tire pressure sensor device and to lock up the setting of the tire pressure sensor device, and then proceed to step E.

Run step D where the main control processor determines whether or not the flag is the first judgment value? And then run step F, if positive, or step G, if negative.

Run step E to set the flag to be a first judgment value that prohibits alteration of the communication protocol, and then to reset and start the timer and then to run step G.

Run step F to reset and start the timer, and then to match the detected tire pressure value with the tire pressure reference value, and then return to run step A again if the detected tire pressure value is greater than the tire pressure reference value, or to run step H if the detected tire pressure value is lower than the tie pressure reference value.

Run step G to determine whether or not the detected tire pressure is greater than the tire pressure reference value? And then return to run step A again if the tire pressure value is greater than the tire pressure reference value, or proceed to run step G if tire pressure value is lower than the tire pressure reference value.

Run step H to determine whether or not the time value of the timer is greater than a predetermined time judgment reference value, and then to return to run step B if the time value of the timer is greater than the predetermined time judgment reference value, or return to run step G if the time value of the timer is smaller than the predetermined time judgment reference value.

Run step B where the main control processor accepts the wireless signal received by the receiver and enables the communication protocol of the tire pressure sensor device to be altered, and then run step I. For example, if the detected tire pressure is 15 psi and the tire pressure reference value is 29 psi, the main control processor accepts the wireless signal received by the receiver and alters the setting of the tire pressure sensor device.

Run step I to stop the counting of the timer and to keep the value of the timer, and then to alter the flag to become the second judgment value, for example, alter the flag to become 1, and then to return to run step A.

The tire pressure sensor device setting method in accordance with the second embodiment of the present invention can prevent alteration of the communication protocol by mistake before inflation of the tire and after the setting of the communication protocol, enhancing the security level of the setting of the communication protocol of the tire pressure sensor device.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tire pressure sensor device setting method for setting a tire pressure sensor, the tire pressure sensor device setting method comprising the step of installing said tire pressure sensor device in a tire of a vehicle and starting up said tire pressure sensor device, and the steps of:
(A) enabling said main control processor to monitor the parameter value and matches monitored parameter value with a predetermined tire pressure reference value, and then proceeding to step (B) if the value of the tire pressure detected by said pressure sensor is smaller than said predetermined tire pressure reference value, or step (C) if the value of the tire pressure detected by said pressure sensor is greater than said predetermined tire pressure reference value;
(B) enabling said main control processor to receive a wireless signal from said receiver for altering the communication protocol of said tire pressure sensor device; and
(C) enabling said main control processor to stop receiving a wireless signal from said receiver and to prohibit alteration of the communication protocol of said tire pressure sensor device, thereby finishing the installation of said tire pressure sensor device.

2. The tire pressure sensor setting method as claimed in claim 1, further comprising, after step (A) and before step (B), the steps of:
(D) enabling said main control processor to determine the flag to be a first judgment value or not to be a first judgment value, and then proceeding to step (F) if the flag is the first judgment value, or step (G) if the flag is not the first judgment value;
(F) resetting the timer and then starting up said timer, and then enabling said main control processor to match the value of the tire pressure detected by said pressure sensor with said predetermined tire pressure reference value, and then returning to step (A) if the value of the tire pressure detected by said pressure sensor is greater than said predetermined tire pressure reference value, or proceeding to step (H) if the value of the tire pressure detected by said pressure sensor is smaller than said predetermined tire pressure reference value;
(G) matching the value of the tire pressure detected by said pressure sensor to be greater or not greater than said predetermined tire pressure reference value, and then returning to step (A) if the value of the tire pressure detected by said pressure sensor is greater than said predetermined tire pressure reference value, or proceeding to step (H) if the value of the tire pressure detected by said pressure sensor is smaller than said predetermined tire pressure reference value; and
(H) determining the time value of the timer to be greater than or not greater than a predetermined time judgment reference value, and then returning to step (B) if the time value of the timer is greater than said predetermined time judgment reference value, or step (G) if the time value of the timer is smaller than said predetermined time judgment reference value.

3. The tire pressure sensor setting method as claimed in claim 1, further comprising, after step (C), the step of: (E) setting the flag to be a first judgment value that prohibits alteration of the communication protocol of said tire pressure sensor device, and then resetting and starting the timer and then proceeding to step (G).

4. The tire pressure sensor setting method as claimed in claim 1, wherein during step (B) said main control processor accepts the wireless signal received by said receiver and enables the communication protocol of said tire pressure sensor device to be altered, and then runs step (I) to stop the counting of the timer and to keep the value of the timer, and then to alter the flag to become a second judgment value, and then to return to run step (A).

5. The tire pressure sensor setting method as claimed in claim 1, wherein starting up said tire pressure sensor device is done by: using a setting tool to transmit a working signal to said tire pressure sensor device and to start up said tire pressure sensor device.

6. The tire pressure sensor setting method as claimed in claim 5, wherein said working signal contains a communication protocol designation code and a trigger code.

7. The tire pressure sensor setting method as claimed in claim 5, wherein said working signal contains a communication protocol software program.

8. The tire pressure sensor setting method as claimed in claim 6, wherein said memory unit of said tire pressure sensor device is blank, having no communication protocol software program stored therein.

9. The tire pressure sensor setting method as claimed in claim 7, wherein said memory unit of said tire pressure sensor device has stored therein a communication protocol software program.
